(19) United States
(12) Patent Application Publication
(10) Pub. No.: US 2008/0215208 A1
(43) Pub. Date: Sep. 4, 2008

(54) System and Method for Interfacing with a Control Network of a Vehicle

(76) Inventor: Jim Carlson, Griffith, IN (US)

Correspondence Address: SNELL & WILMER LLP (OC), 600 ANTON BOULEVARD, SUITE 1400, COSTA MESA, CA, 92626, US

(21) Appl. No.: 11/913,646

(22) PCT Filed: May 3, 2006
(86) PCT No.: PCT/US06/17022

§ 371 Date: Mar. 18, 2008

Related U.S. Application Data
(60) Provisional application No. 60/676,968, filed on May 3, 2005.

(51) Int. Cl. G06F 19/00; G06F 7/00; G01M 17/00

(52) U.S. Cl. 701/35; 701/36; 701/29

(57) ABSTRACT

According to one embodiment, the disclosure relates to a system adapted for, among others, interfacing with a control network of a vehicle, said system comprising a program for monitoring data available in said control network and adapted to send selected data to a data link of said vehicle; a processor for receiving said selected data from said data link and decoding said selected data into decoded data available for subsequent use.

This disclosure claims the filing date-benefit of U.S. Provisional Application No. 60/676,968 filed May 3, 2005, the specification of which is incorporated herein in its entirety.

### BACKGROUND

The electronic control networks of machines, and in particular vehicles, have evolved extensively. Current vehicles engage a large array of distributed sensors and microcontrollers to carry out increasingly complicated monitoring and control functions. The increased demand has seen simple wired networks replaced by data buses, multiplexers and wireless data transmission. Many vehicle manufacturers have adapted a Controller Area Network (“CAN”) standard to transmit data throughout these electronic control networks.

One application of CAN-based control networks concerns processing vehicle Diagnostic Trouble Codes (“DTC”), performance and operational information. One or more electronic control units (“ECU”) on a vehicle monitor the control network and provide an indication such as an ‘Engine Check Light’, ‘Maintenance Indication Lamp’ or the like, when a problem is detected. Such indications are communicated to the operator for immediate attention. Another application is to communicate certain service milestones to the operator. For example, indications can be made regarding when preventive maintenance service is due. Still another application of the ECU is to control the vehicle's electromechanical actuators including, fuel injectors cycles, spark-plug ignition timing and anti-lock braking system.

Conventional systems provide limited means for communicating a potential problem to the operator. For example, a check engine light can be caused by a faulty oxygen sensor in an array of such sensors or it can be an indication that the engine's oil supply is depleted. Other than contacting the service department of a dealer, the operator will have no means for interpreting why the indication has been illuminated.

Likewise, limited means are provided for the vehicle user or, for example, a local technician, to access the extensive data available in the control network. Typically, proprietary diagnostic software must run to interface with information in the control network. Such proprietary diagnostic software are devised by manufacturers and distributed to authorized dealerships' service centers or to approved service providers. For example, domestic and foreign manufacturers such as Ford, General Motors, Honda and Audi use proprietary software (and hardware) for communicating electronic control information to the technician. Such software is defined by a proprietary protocol and format and is not interchangeable to non-proprietary devices.

While in some instances standardized data formats and protocols are communicable to generic diagnostic software, a proprietary hardware is often required to gain access to the relevant information on the control network. Thus, an independent technician is often not equipped to interface all of the available proprietary diagnostic software or hardware.

The Environmental Protection Agency (“EPA”) requires vehicles manufactured or sold in the U.S. to include a standard Onboard Diagnostic (“OBD”) connector plug in order to provide access to data related to the vehicle's emissions. The EPA requires that when the vehicle exceeds emission thresholds, diagnostic information be stored in the vehicle's central computer so that it can be read during the subsequent repair or inspection cycle. A conventional OBD is a serial bus (or a port) with a 16-cavity connector which enable a peripheral processor to read emission information stored. The second generation OBD systems (“OBD II”) monitors a broad range of vehicle performance criteria including, emissions, speed, mileage, engine temperature and intake manifold pressure. The OBD II systems can also be configured to monitor manufacturer-specific data such as transmission performance, alarm, brakes and geo-positioning system (“GPS”).

While U.S. Pat. No. 6,636,790B1 to Lightner et al. provides a device that connects to the standard OBD connector plug in order to wirelessly access data on a vehicle's central computer, non-emissions data on the OBD II bus is frequently in a proprietary protocol and format inaccessible to generic diagnostic programs. Furthermore, vehicle control networks may use internal or wireless data buses not connected to the OBDII bus. Thus, there is a need to provide a simple system and method to access and interpret a greater portion of information available on a vehicle's control network.

### SUMMARY

According to one embodiment, the disclosure relates to a system adapted for, among others, interfacing with a control network of a vehicle, said system comprising a program for monitoring data available in said control network and adapted to send selected data to a data link of said vehicle; a processor for receiving said selected data from said data link and decoding said selected data into decoded data available for subsequent use.

According to another embodiment, the disclosure relates to a method for interfacing with a control network of a vehicle, said method comprising the steps of installing a program in a controller of said control network, said program retrieving data available to said controller, said program sending data selected therefrom to a data link of said vehicle, connecting a processor to said data link and to receive the selected data, and decoding said selected data into decoded data format being available for subsequent use.

In still another embodiment, the disclosure relates to a system for interfacing an aftermarket peripheral computer node to a the CAN bus. The system comprises a memory, a processor and an interface logic. The memory stores program codes. The processor communicates with the memory and executes the program code. The interface logic interfaces the processor with an interconnecting bus, for example, the Real-Time System Integration (RTSI) bus. Once the program code is executed, the processor performs a CAN event in response to the interface logic receiving an RTSI trigger signal on a selected line of the RTSI bus. A peripheral device also coupled to the host computer assert the trigger signal in response to the peripheral device receiving and/or transmitting data. Furthermore, the interface logic is configured to assert RTSI trigger signal on a selected line of the RTSI bus in response to the processor performing a CAN event. In one embodiment, CAN events include transmission/reception of a CAN frame. The peripheral device may be configured to perform a data transfer in response to receiving the trigger signal.

### BRIEF DESCRIPTION OF THE DRAWINGS

FIG. 1 is a schematic diagram of a system according to one embodiment of the disclosure; and

FIG. 2 is an exemplary diagram representing a method according to one embodiment of the disclosure.

### DETAILED DESCRIPTION

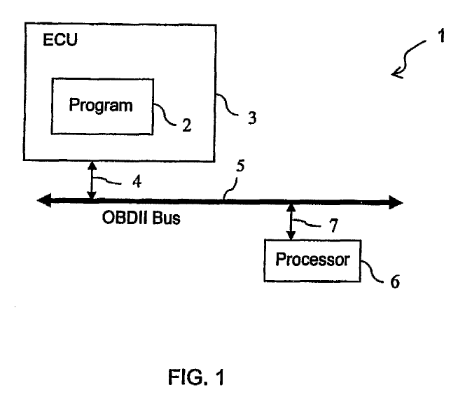

FIG. 1 is a schematic diagram of a system 1 according to one embodiment of the disclosure. Specifically, FIG. 1 shows program 2 resident on Electronic Control Unit (ECU) 3, ECU 3 being a controller of a control network of a vehicle (not shown). ECU 3 can be connected via interface 4 to the Onboard Diagnostic II bus (OBDII bus) 5. The OBDII bus 5 can be further connected to processor 6 via connection interface 7. While the embodiment of FIG. 1 shows program 2 resident on the ECU, the principles disclosed herein are not limited to this embodiment. In another embodiment, program 2 can be part of a circuitry configured to communicate with the ECU. In addition, the implementation of the principles disclosed herein are not limited to OBDII-type busses and can be equally applicable to conventional OBD-type busses.

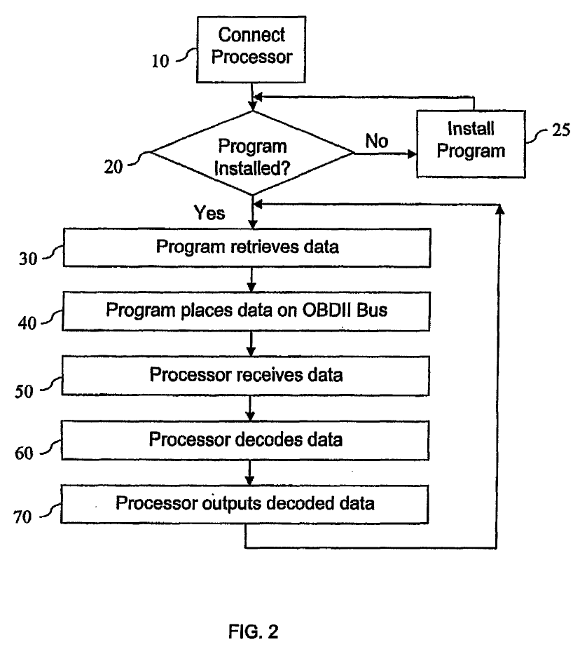

FIG. 2 is an exemplary diagram representing a method according to one embodiment of the disclosure. The method can be implemented, for example, in the embodiment of FIG. 1. In particular, the block diagram of FIG. 2 represents the structure of an exemplary sub-routine executed by program 2 and processor 6. Initially, processor 6 is connected to OBDII bus 5 in step 10. Processor 6 can be one of multiple processors. Generally processor 6 may be connected via connecting interface 7. In one embodiment, a standard 16 pin wire connector may be inserted into the vehicle's OBDII bus connector port. In the optional step 20, processor 6 queries OBDII bus 5 to determine whether program 2 exists on the control network. If program 2 has not been previously installed, program 2 is installed in ECU 3 in step 25.

Once program 2 is detected, it monitors and selects data from the control network using ECU 3 in step 30. Selected data may include DTCs, operational data, Maintenance Indicator Lamp (MIL) status, and performance data. In step 40, program 2 places the selected data on OBDII bus 5 non-invasively, using the protocol of the control network. In step 50, processor 6 retrieves the selected data from OBDII bus 5. Processor 6 then decodes the selected data from the protocol of the control network in step 60 and in step 70 the decoded data is made available to peripheral devices. Steps 30 through 70 are performed repeatedly until no further information is required. In an alternative embodiment, the results of steps 30-70 is stored in a memory module for future access. In addition, these steps need not be triggered automatically and may be triggered in response to an internal or external stimulus. Once the information is translated to a non-proprietary protocol or a non-proprietary format, non-proprietary devices can be used to receive and process the information.

In another embodiment, processor 6 is interposed between ECU 3 and Bus line 5. According to this embodiment, information received from ECU 3 is decoded to a format and protocol different from the proprietary format and protocol used by the ECU. The result can then be communicated to a peripheral device through Bus 5 or through a separate communication channel. For example, a dedicated communication port can be provided to exclusively communicate information from processor 6. Alternatively, the processor can communicate information through wireless means.

In the exemplary embodiments of FIGS. 1 and 2, program 2 operates within the protocol of the vehicle control network using ECU 3. The control network may use a CAN-based protocol, or some other protocol, and may include further proprietary protocols in their messaging and control functions. In addition, ECU 3 may communicate information using a proprietary format which is not readable to other peripheral equipment. ECU 3 monitors and controls a network of vehicle sensors and microcontrollers (not shown) using those protocols. ECU 3 uses the OBDII bus to interface with at least a portion of the network. Program 2 monitors data being processed in ECU 3 and may retrieve further data on the control network using the non-invasive, non-conflicting, proprietary protocol in use. Once the data is retrieved and decoded by processor 6, it is available for processing by diagnostic systems available to the subscriber. In one embodiment, Processor 6 outputs the data as TTL level serial data using the OBD II communication port. In an alternative embodiment, data buses other than a OBD II may be used. For example, in control networks using a wireless data link, program 2 and processor 6 may interface using the wireless data link.

In a further embodiment, program 2 may receive commands from processor 6. Such commands may include querying for specific system data to assist in troubleshooting. Such commands may further include adjustments, for example, a sensor alarm set-point adjustment. In another embodiment, processor 6 and/or program 2 may limit the level of access granted to a user based on a predetermined authorization access scheme. For example, a licensed technician may gain more access to the control network than a less qualified technician.

According to one embodiment, the disclosure relates to a system that allows DTC, performance, and operational information to be sent on CAN-based vehicles to a simple monitoring interface to allow monitoring of said information without the need for specific CAN implementation or CAN hardware.

In one embodiment of the disclosure, a system may include two main components. The first component can be the BIN (Binary) operational file that can be uploaded onto the ECU for gathering various DTC, operational, Maintenance Indication Lamp (MIL) status and Performance information and sending the information to the OBD II bus/plug interface as a specific proprietary, non-invasive, non-conflicting protocol. It should be noted that the term information is an inclusive term and is intended to include any information available to ECU or any other electronic control system of the vehicle.

The second component may include a translation processor that can obtain the information being sent from the BIN file on the OBD II data bus. The processor can be one or an array of microprocessors or circuits. The information sent from the BIN operational file can be in a specific proprietary protocol (or format) that the processor board receives and decodes. This processor board can capture the information being sent from the BIN operational file program along the OBD II data bus lines, without interfering in the normal operation of the OBD II data bus. The decoding process may include translating the information to a non-proprietary protocol and/or to a non-proprietary digital format.

An exemplary process includes a binary (BIN) file (program) that can be uploaded to the vehicle's ECU permanently. Once uploaded, this file will gather DTC, performance, MIL status and operational information from various systems of the vehicle, as well as the ECU. The information gathered can be dependent upon the settings of the BIN file. After gathering this information, the program will send this information through the vehicle's OBD II data bus system in a specific format so as not to disturb the normal operation of the OBD II data bus. This information can be, for example, multiplexed with the OBD II's normal operation. A processor board connected to the OBD II bus can be used to capture this data as it is transmitted. The captured data can then be converted into serial form and transmitted out the processor board as TTL level serial data.

As an example of this embodiment, suppose a vehicle's oxygen sensor fails. The MIL lamp can then activate due to a problem with the vehicle. The BIN file would sense that the MIL lamp has been activated, and it would then obtain the DTC for the oxygen sensor failure. The BIN file would then communicate the information to the OBD II bus in the proprietary format as to not disturb the normal operation of the OBD II data bus. The processor attached to the OBD II bus would receive this information and then convert the information to serial form that could then be sent out as a TTL level serial output to another system. In an alternative embodiment, the information is communicated to the processor through a separate direct link without disturbing the OBD II; thereafter the information is decoded or translated to an appropriate format or protocol and communicated to a peripheral device.

In still another embodiment, the processor is integrated with the ECU. Once activated, the information available to the ECU is translated by the processor and communicated to a peripheral equipment through the OBD II component, through a wireless component or through a dedicated communication channel (and hardware).

In another embodiment, the disclosure relates to system, apparatus and method for synchronizing a CAN interface with a peripheral device. The apparatus may include a memory for storing executable instructions in the form of a program, one or more processor communicating with the memory and configured to execute instructions, a bus interface logic communicating with one or more of the processors and a CAN interface logic for interfacing with a CAN bus and executable on a processor. An interconnecting bus can be used to couple the peripheral device to the CAN interface via the bus interface logic of the of the CAN interface. The peripheral device can be operable to generate an asynchronous trigger on the interconnecting bus in response to a peripheral event. The CAN interface can also be operable to receive the asynchronous trigger via the interconnecting bus. At least one of the processors can be operable to execute the program code to perform a CAN event in response to the CAN interface receiving the asynchronous trigger on the interconnecting bus from the peripheral device. The CAN event can be performed substantially synchronous with the peripheral event. Finally, the generation and receive of the asynchronous trigger and performing the CAN event can be performed independently of the I/O bus.

An apparatus according to an embodiment of the disclosure includes a system for operating a CAN interface. The system may comprise the CAN interface where both the CAN interface and peripheral device may be coupled to a host computer or to a peripheral bus of the host computer. The CAN interface may couple through a CAN bus to CAN devices, which in turn may be coupled to a physical system or unit under test. The peripheral device may also be coupled through one or more sensors and/or actuators to the physical system. The CAN interface and peripheral device can be directly coupled by an interconnecting bus, such as the Real-Time System Integration (RTSI) bus.

The CAN interface may comprise a memory, an embedded processor, bus interface logic, and CAN interface logic. The memory may store program codes, and the embedded processor couples to the memory and executed the program code. The bus interface logic interfaces the CAN interface with the interconnecting bus, wherein the CAN interface and the peripheral device may communicate with each other through the interconnecting bus, which can define a wireless channel. The peripheral device may be operable to assert a trigger signal on a selected line of the interconnecting bus in response to processing/transfer event occurring in the peripheral device. For example, the peripheral device may assert the trigger signal in response to the transmission (or initiation of transmission) of analog and/or digital signals to an external device or physical system. Conversely, the peripheral device may assert the trigger signal in response reception (or the initiation of reception) of analog and/or digital signals from an external device or physical system. The embedded processor may be operable to perform a CAN event in response to the bus interface logic receiving the trigger signal on the selected line of the interconnecting bus. In this case, CAN events may include the transmission of a CAN frame, and/or the generation and storage of a trigger timestamp defining a time-of-occurrence of the trigger signal.

Furthermore, the CAN interface may be configured to assert a trigger signal on a selected line of the interconnecting bus in response to the CAN interface; for example, the embedded processor in the CAN interface performing a CAN event. In this case, the CAN event may comprise transmission of a CAN frame, reception of a CAN frame, reception of an indicating that a user application program (running on the host computer) has called a particular CAN function, or any combination thereof. In response to receiving the trigger signal on the selected line of the interconnecting bus, the peripheral device may perform a processing and/or transfer event. For example, the peripheral device may initiate a signal transmission and/or a signal reception in response to the trigger signal such as to unlock the vehicles door. Thus, the CAN interface and the peripheral device are operable to synchronize operations through use of the interconnecting bus thereby allowing improved measurement and control operations in measuring and/or controlling the physical system.

In one embodiment, the disclosure relates to a system for synchronizing a CAN interface with a peripheral device, the system including (a) a peripheral device, coupled to a host computer via an I/O bus; (b) one or more CAN interfaces, coupled to the host computer via the I/O bus, wherein at least one CAN interface includes: (i) a memory configured to store program code; (ii) an embedded processor coupled to the memory, and configured to execute the program code; (iii) bus interface logic coupled to the embedded processor; and (iv) CAN interface logic coupled to the embedded processor and configured for interfacing with a CAN bus; and (v) an interconnecting bus, coupling the peripheral device to the CAN interface via the bus interface logic of the CAN interface. The peripheral device can be operable to generate an asynchronous trigger on the interconnecting bus in response to a peripheral event. The CAN interface can be operable to receive the asynchronous trigger via the interconnecting bus. The processor can be operable to execute the program code to perform a CAN event in response to said CAN interface receiving the asynchronous trigger on the interconnecting bus from the peripheral device, wherein the CAN event is performed substantially synchronously with the peripheral event. The generation and receipt of the asynchronous trigger and performing the CAN event may be performed independently of the I/O bus.

Furthermore, the CAN event may include transmission of a CAN frame onto the CAN bus. The CAN event may include generating a timestamp defining a time-of-occurrence of the asynchronous trigger and storing the timestamp in said memory. In addition, the bus interface logic can be operable to receive the asynchronous trigger on a first line of a plurality of lines on the interconnecting bus and the processor can be operable to receive configuration information from the host computer, wherein the configuration information selects the first line among a plurality of lines of said interconnecting bus. The interconnecting bus can be a Real-Time System Integration (RTSI) bus.

In a system for synchronizing a CAN interface with a peripheral device according to one embodiment, the system comprises a peripheral device, coupled to a host computer via an I/O bus; a CAN interface, coupled to the host computer via the I/O bus, wherein the CAN interface comprises: a memory configured to store program code; an embedded processor coupled to the memory and configured to execute the program code; bus interface logic coupled to the embedded processor; and CAN interface logic coupled to the embedded processor and adapted for interfacing with a CAN bus; and an interconnecting bus, coupling the peripheral device to the CAN interface via the bus interface logic of the CAN interface. Wherein the CAN interface is operable to generate an asynchronous trigger on the interconnecting bus in response to a CAN event; the peripheral device is operable to receive the asynchronous trigger via the interconnecting bus; the bus interface logic of the CAN interface is configured to assert the asynchronous trigger on the interconnecting bus to the peripheral device in response to the embedded processor performing a CAN event, wherein the peripheral device is operable to perform a peripheral event substantially synchronously with the CAN event upon receiving the asynchronous trigger on the interconnecting bus from the CAN interface; and the generating and receipt of the asynchronous trigger, and performing the peripheral event are performed independently of the I/O bus. The CAN event can comprise transmission of a CAN frame, reception of a CAN frame, receiving an indication of a function call invoked by a user application program running on the host computer.

In a method for synchronizing a CAN interface with a peripheral device, wherein the CAN interface and the peripheral device are both coupled to a host computer via an I/O bus, wherein the CAN interface and the peripheral device are directly coupled through an interconnecting bus, the method comprising the steps of (a) the peripheral device generating an asynchronous trigger on the interconnecting bus in response to a peripheral event; (b) the CAN interface receiving the asynchronous trigger from the peripheral device through the interconnecting bus; and (c) the CAN interface performing a CAN event in response to the asynchronous trigger. Wherein, in response to receiving the asynchronous trigger, the CAN interface can perform the CAN event substantially synchronously with the peripheral event; and wherein the generation and receipt of the asynchronous trigger, and performing the CAN event are performed independently of the I/O bus. In one embodiment, the peripheral device transmits the asynchronous trigger in response to performing a data transfer.

In another embodiment, the disclosure relates to a method for synchronizing a CAN interface with a peripheral device, wherein the CAN interface and the peripheral device are both coupled to a host computer using an I/O bus, wherein the CAN interface and the peripheral device are directly coupled through an interconnecting bus. The method comprises the steps of (a) the CAN interface performing a CAN event; (b) the CAN interface transmitting an asynchronous trigger to the peripheral device through the interconnecting bus in response to the CAN interface performing the CAN event. Wherein the asynchronous trigger is operable to direct the peripheral device to perform a peripheral event substantially synchronously with the CAN event in response to the asynchronous trigger; and wherein the transmission of the asynchronous trigger and performing each of the CAN event and the peripheral event are performed independently of the I/O bus.

In another embodiment, the disclosure relates to a system for synchronizing a CAN interface device with a peripheral device, the system comprising: a host computer system; a peripheral device coupled to the host computer system via an I/O bus, wherein the peripheral device couples to the physical system; a CAN bus; one or more CAN devices coupled to the CAN bus, wherein the one or more CAN devices couple to the physical system; a CAN interface device coupled to the host computer system via the I/O bus; and an interconnecting bus, coupling the peripheral device to the CAN interface device; wherein the CAN interface device and the peripheral device are operable to communicate with each other using the interconnecting bus to synchronize measurement and/or control operations on the physical system, wherein said communicating is performed independently of the I/O bus; wherein said communicating with each other comprises using an asynchronous trigger signal.

The CAN interface device can be configured to provide the asynchronous trigger signal over the interconnecting bus to the peripheral device in response to a CAN event occurring in the CAN interface device. The peripheral device can be operable to receive the asynchronous trigger signal from the interconnecting bus, and to perform a peripheral event in response to receiving the asynchronous trigger signal.

In still another embodiment, the disclosure relates to a method for correlating measurements in a system comprising a host computer system coupled to a CAN interface and a peripheral device via an I/O bus, wherein the CAN interface is adapted to couple through a CAN bus to one or more CAN devices, wherein the CAN devices couple to a physical system, wherein the peripheral device is also adapted to couple to the physical system, wherein the peripheral device and the CAN interface are directly coupled through an interconnecting bus, the method comprising: the CAN interface acquiring CAN data frames from the CAN bus; the CAN interface generating CAN timestamps for the acquired CAN data frames; the peripheral device transmitting an asynchronous trigger signal on the interconnecting bus to the CAN interface in response to a peripheral event performed by the peripheral device; the CAN interface receiving the asynchronous trigger signal and generating a trigger timestamp for the asynchronous trigger signal; and determining from the CAN timestamps and the trigger timestamps one or more of the CAN data frames which correlate in time with the peripheral event; wherein the transmission and receipt of the asynchronous trigger signal and the performing peripheral event are performed independently of the I/O bus.

In still another embodiment, the disclosure relates to a method for correlating measurements in a system comprising a host computer system coupled to a CAN interface and a peripheral device using an I/O bus, wherein the CAN interface is adapted to couple through a CAN bus to one or more CAN devices, wherein the CAN devices couple to a physical system, wherein the peripheral device is also adapted to couple the physical system, wherein the peripheral device and the CAN interface are directly coupled through an interconnecting bus, the method comprising: the peripheral device transferring data values; the peripheral device generating peripheral timestamps indicating times-of-transference of said data values; the CAN interface performing a CAN frame transfer; the CAN interface transmitting an asynchronous trigger signal on the interconnecting bus to the peripheral device in response to the CAN frame transfer; the peripheral device receiving the trigger signal and generating a trigger timestamp indicating a time-of-occurrence of the asynchronous trigger signal; and determining from the peripheral timestamps and the trigger timestamp one or more of the data values which correlate in tie with the CAN frame transfer; wherein the transmission and receipt of the asynchronous trigger signal are performed independently of the I/O bus.

The step of peripheral device transferring data values can include the peripheral device acquiring data values from the physical system. Alternatively, the step of peripheral device transferring data value can include the peripheral device transmitting the data value to the physical system. Moreover, the I/O bus may include one or more of an ISA bus; and a PCI expansion bus.

The specific embodiments presented herein are exemplary in nature and are not intended to limit the scope of the disclosure. Any permutation, modification and deviation from the specific embodiments are considered to be well within the scope of the principles disclosed herein.

1-12. (canceled)

13. A method for accessing proprietary information in an Electronic Control Unit (“ECU”) of a vehicle and reporting various operation information available from said ECU to a generic peripheral device, the method comprising:
instructing the ECU to provide a duplicate of information communicated to or from the ECU;
receiving the duplicate information from the ECU in a first format;
translating the duplicate information from the first format to a second format, the second format different from the first format and readable to the peripheral component;
reporting the translated information to the peripheral component;
wherein translating the duplicate information from the first format to a second format is implemented by a non-native program installed on the ECU.

14. The method of claim 13, further comprising storing the translated information.

15. The method of claim 13, further comprising using an onboard diagnostic connector plug to communicate the translated information to a peripheral device.

16. The method of claim 13, wherein the step of reporting the translated information further comprises wirelessly communicating the information to a receiver.

17. The method of claim 13, wherein the ECU encodes the information in a proprietary format.

18. The method of claim 13, wherein the step of reporting the translated information to the peripheral component does not interfere with an alternative operation of an onboard diagnostic connector plug.

19. A system for interfacing with a control network of a vehicle, said system comprising:
a circuitry including a microprocessor and a memory for compiling a database of digital instructions, said digital instructions configured to direct the circuitry to:
monitor the control network for information;
retrieve at least a select portion of said information in a first format readable to the control network;
translate the select portion of the information to a second format, the second format readable to at least one peripheral component; and
communicate the translated information to the peripheral component using an onboard vehicle communication device; wherein the circuitry is installed on an Electronic Control Unit of a vehicle as an aftermarket part.

20. The system of claim 19, wherein said circuitry defines a virtual circuit.

21. The system of claim 19, wherein the vehicle communication device further comprises a physical communication port.

22. The system of claim 19, wherein the vehicle communication device further comprises a wireless communication port.

23. A system for interfacing with a controller area network (“CAN”) of a vehicle, said system comprising:
a circuitry including a microprocessor and a digital memory for compiling a database of digital instructions, said digital instructions configured to direct the circuitry to:
monitor the CAN for information;
retrieve at least a select portion of said information in a first format readable to the CAN;
communicate the select portion of said information to the peripheral component using an onboard vehicle communication device;
a second circuitry with a microprocessor and a digital memory residing in the peripheral device and translating said information to a second format readable to the peripheral device;
wherein the circuitry is installed on an Electronic Control Unit of a vehicle as an aftermarket part.

24. A method for accessing the electronic control system (“ECU”) of a vehicle, the method comprising:
installing a non-native program on the ECU system, the ECU system operating on a Controller Area Network (CAN) of the vehicle and using a proprietary communication format;
detecting information communicated through the ECU in the proprietary format;
translating the information received from the ECU from the proprietary format to information in an alternative format; and
providing the translated information in the alternative format to a peripheral device;
wherein the non-native program is an aftermarket parasitic program for detecting communications through the ECU in the proprietary format.

25. The method of claim 24, wherein the non-native program intercepts information communicated through the ECU system.

26. The method of claim 24, wherein the step of receiving a duplicate information further comprises monitoring information communicated through the ECU without specific CAN implementation.

27. A vehicle Electronic Control System (“ECU”) comprising:
a first circuitry for receiving control information from a first node of the vehicle in a first format and transmitting the information to a second node of the vehicle in a second format, the first circuitry using a proprietary protocol for communicating with the first node and the second node;
a second circuitry for detecting information received or transmitted by the first circuitry in the proprietary protocol and translating the information to a non-proprietary format;
a bus for communicating with at least one of the first circuitry or the second circuitry;
wherein the second circuitry is an aftermarket part installed as an addition to the first circuitry.

28. The system of claim 27, wherein the first circuit and the second circuit are integrated into the ECU.

29. The system of claim 27, wherein the second circuit initiates communication with the first circuit after detecting a the first circuit's receipt of control information.

30. The system of claim 27, wherein the second circuit initiates communication with the first circuit in response to an external request for information.

31. The system of claim 27, wherein the second circuit translates the information into a non-proprietary format substantially synchronously with the direction of information by the ECU.

32. The system of claim 27, wherein the second circuit further comprises means for wirelessly transmitting the detected information.

33. The system of claim 27, wherein the second circuit further comprises a storage means for storing the detected information.

34. The system of claim 27, wherein the second circuit is programmed to receive external instructions to query the first node through the first circuit.
